(19) United States
(12) Patent Application Publication
(10) Pub. No.: US 2007/0189474 A1
(43) Pub. Date: Aug. 16, 2007

(54) Initiating ecommerce sessions using multimedia ringback tones

(75) Inventor: Yigang Cai, Naperville, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/340,885

(22) Filed: Jan. 27, 2006

(51) Int. Cl. H04M 15/06; H04M 1/56

(52) U.S. Cl. 379/142.01

(57) ABSTRACT

Communication networks and associated methods are disclosed that provide ecommerce services using multimedia ringback tones. A communication network of the invention comprises a network node and a multimedia ringback system. The network node receives a call from a calling party to a called party and routes the call to multimedia ringback system. Multimedia ringback system identifies a multimedia ringback tone for the call that includes an advertisement for an ecommerce entity, and provides the multimedia ringback tone to the calling party. The multimedia ringback system then receives a request to initiate an ecommerce session with the ecommerce entity indicated in the multimedia ringback tone, and routes the call to an ecommerce server of the ecommerce entity responsive to the request.

### BACKGROUND OF THE INVENTION

1. Field of the Invention

The invention is related to the field of communication networks and, in particular, to initiating ecommerce sessions using multimedia ringback tones.

2. Statement of the Problem

If a calling party places a call to a called party, the sounds heard by the calling party when waiting for the called party to answer the call is referred to as ringback tones. The communication network over which the call is placed provides the ringback tones to the calling party, which is typically a ringing sound. A present trend of service providers is to offer customized ringback tones to its subscribers. Customized ringback tones may comprise music, songs, sound clips, audio messages, prerecorded greetings, etc, that the communication network plays as ringback tones instead of or in addition to the traditional ringing sound. Customized ringback tones can be associated with specific directory numbers of the calling party, such as with phone lists or exclusion lists. The subscriber can also set conditions for when, for whom, or what is played for the ringback tones based on time, day of the week, the calling party, etc. Customized ringback tones have generated high revenues for services providers.

Emerging multimedia phones (e.g., wireless handsets, broadband wireline phone sets, SIP phones, etc) allow text, animated images, audio/video clips, etc, as multimedia ringback tones to the calling party. The subscriber can define selected images or video clips as multimedia ringback tones and store them in the communication network. If a calling party calls the subscriber, the communication network plays back the selected image or video clip to the calling party based on the multimedia ringback tone profile defined by the subscriber.

Both regular ringback service and multimedia ringback service can be used for business applications. For example, the communication network may play the theme song of a company as ringback tones. The communication network may play other marketing information as regular ringback tones or multimedia ringback tones. Unfortunately, service providers have not effectively used multimedia ringback tones to facilitate ecommerce between the calling party and certain ecommerce entities.

### SUMMARY OF THE SOLUTION

The invention provides advantages over prior communication networks and methods by providing advertising for ecommerce entities using multimedia ringback tones, and initiating ecommerce sessions with the ecommerce entities responsive to a request by a calling party. The communication network takes advantage of the dead time between placing a call and when the called party answers the call to provide advertisements of ecommerce entities to the calling party. If the calling party identifies a product or service he/she would like to purchase, the calling party can interrupt the call and request access to the advertised ecommerce entity. Responsive to the request, the communication network routes the call to an ecommerce server of the selected ecommerce entity to allow the calling party to purchase the desired products or services. The service provider operating the communication network can advantageously generate additional revenue for the ecommerce entities, some of which may be shared with the service provider.

In one embodiment of the invention, a communication network comprises a network node and a multimedia ringback system. The network node is adapted to receive a call from a calling party to a called party, and route the call to the multimedia ringback system. The multimedia ringback system is adapted to identify a multimedia ringback tone for the call where the multimedia ringback tone includes an advertisement for an ecommerce entity, and provide the multimedia ringback tone to the calling party while the calling party waits for the call to be answered by the called party. The multimedia ringback system is further adapted to receive a request to initiate an ecommerce session with the ecommerce entity indicated in the multimedia ringback tone, and route the call to an ecommerce server of the ecommerce entity responsive to the request.

The invention may include other exemplary embodiments described below.

### DESCRIPTION OF THE DRAWINGS

The same reference number represents the same element on all drawings.

FIG. 1 illustrates an exemplary communication network in an exemplary embodiment of the invention.

FIG. 2 is a flow chart illustrating an exemplary method of operating a communication network to provide ecommerce services using multimedia ringback tones in an exemplary embodiment.

FIG. 3 illustrates another exemplary communication network in an exemplary embodiment.

FIG. 4 is a message diagram illustrating an exemplary operation of the communication network of FIG. 3 in an exemplary embodiment.

FIG. 5 is a message diagram illustrating another exemplary operation of the communication network of FIG. 3 in an exemplary embodiment.

FIG. 6 is a flow chart illustrating a method of operating a calling device in an exemplary embodiment.

### DETAILED DESCRIPTION OF THE INVENTION

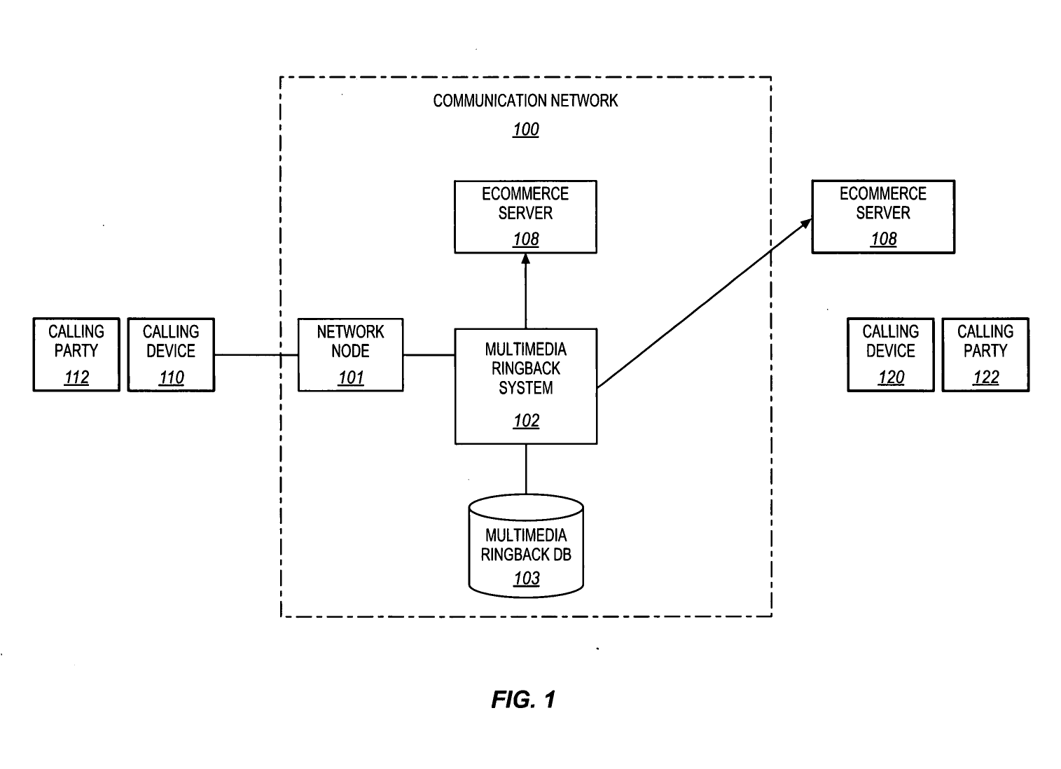

FIGS. 1-6 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an exemplary communication network 100 in an exemplary embodiment of the invention. Communication network 100 may comprise a wireline network, an IP Multimedia Subscriber (IMS) network, or a wireless network such as a Code Division Multiple Access (CDMA) network, a Time Division Multiple Access (TDMA) network, a Global System for Mobile Communication (GSM) network, or a Universal Mobile Telecommunications System (UMTS) network. Communication network 100 is adapted to provide communications between calling party 112 (through calling device 110) and called party 122 (through called device 120). Devices 110 and 120 comprise any communication devices, such as a wireline phone, a wireless (mobile) phone, a PDA, a PC, a VoIP phone, a SIP-based phone, etc. Communication network 100 may include other networks, systems, or devices not shown in FIG. 1.

Communication network 100 includes a network node 101, a multimedia ringback system 102, and a multimedia ringback database 103. Communication network 100 is also illustrated as including an ecommerce server 108 or communicating with an ecommerce server 108 remote from communication network 100. Network node 101 includes any switch, server, or other device that serves calling device 110 for a call. For instance, network node 101 may comprises a switch in a wireline network or a Mobile Switching Center (MSC) in a wireless network. Multimedia ringback system 102 comprises any system that handles multimedia ringback tones for communication network 100. Communication network 100 allows for customized multimedia ringback tones. The customized multimedia ringback tones may be predefined by called party 122 or other entities associated with called party 122. Multimedia ringback system 102 handles the customized multimedia ringback tones, such as by providing a mechanism to allow called party 122 to predefine the multimedia ringback tones, by storing and maintaining the customized multimedia ringback tones in multimedia ringback database 103 or other databases, etc. Multimedia ringback system 102 may comprise a single, independent server or system in communication network 100, such as an Intelligent Peripheral (IP) or an Application Server (AS), or may be distributed among multiple servers or systems in communication network 100. Multimedia ringback system 102 may also be incorporated in network node 101.

Multimedia ringback database 103 comprises any database configured to store information on multimedia ringback tones. The information on the multimedia ringback tones may include actual content for multimedia ringback tones, such as audio files, video files, etc. The information on the multimedia ringback tones may also or alternatively include property information, such as a title of a multimedia ringback tone, an owner of a multimedia ringback tone, a location of a multimedia ringback tone (e.g., a link, a network address, etc), applicable directory numbers for the multimedia ringback tone, etc. Multimedia ringback database 103 does not necessarily store each of the actual multimedia ringback tones, but should include information on the multimedia ringback tones to be used in communication network 100. Multimedia ringback database 103 is accessible by multimedia ringback system 102. Multimedia ringback database 103 may be integrated with multimedia ringback system 102, or may be distributed among multiple servers or systems in communication network 100 or on other servers or systems in other networks (not shown).

Ecommerce server 108 comprises any system or server configured to facilitate the buying or selling of products and/or services over a network, such as the Internet, corporate extranets, etc. Ecommerce server 108 is also illustrated as being local to or included in communication network 100, and is illustrated as being remote from communication network 100, such as in an extranet of an ecommerce entity. If ecommerce server 108 is remote from communication network 100, then multimedia ringback system 102 may communicate with ecommerce server 108 through an IP network (not shown) or another type of transport network.

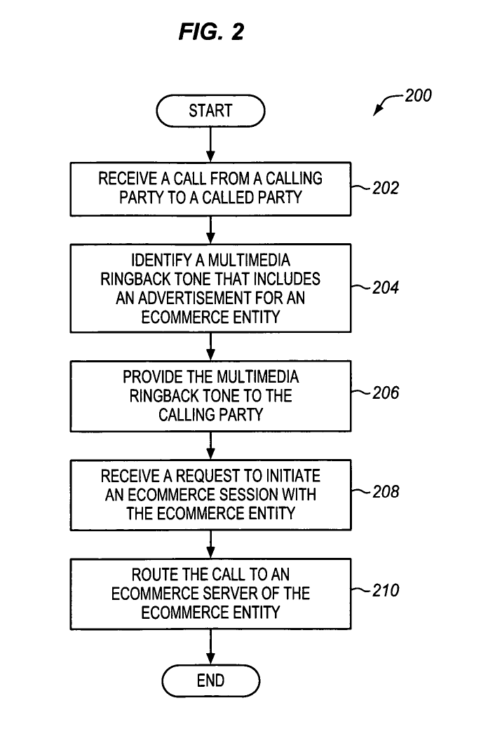

When in operation, assume that calling party 112 places a call to called party 122 through calling device 110. FIG. 2 is a flow chart illustrating an exemplary method 200 of operating communication network 100 to provide ecommerce services using multimedia ringback tones in an exemplary embodiment of the invention. The steps of method 200 will be described with reference to communication network 100 in FIG. 1. The steps of the flow chart in FIG. 2 are not all inclusive and may include other steps not shown.

In step 202, network node 101 receives a call from calling party 112 to called party 122 through calling device 110. Network node 101 processes the call to determine if customized multimedia ringback tones are to be applied for this call. If so, network node 101 routes the call to multimedia ringback system 102. Network node 101 also attempts to set up the call to called party 122. For instance, network node 101 may route the call to a network node (not shown) that serves called party 122.

In step 204, multimedia ringback system 102 identifies a multimedia ringback tone for the call that includes an advertisement for an ecommerce entity. A multimedia ringback tone comprises any multimedia-type message, such as text, audio, video, etc, that is played while calling party 112 waits for called party 122 to answer a call. Multimedia ringback system 102 may identify the multimedia ringback tone in many desired ways. For instance, multimedia ringback system 102 may receive caller identification information with the call, such as a directory number of calling party 112 and a directory number of called party 122, and query multimedia ringback database 103 with the directory number of calling party 112. Multimedia ringback database 103 may respond with the appropriate multimedia ringback tone corresponding with the directory number of calling party 112.

Called party 122 or an entity associated with called party 122 has predefined one or more multimedia ringback tones stored in multimedia ringback system 102, multimedia ringback database 103, or in other servers or databases to play before answering calls. Called party 122 may comprise an ecommerce entity that predefines advertisements in multimedia ringback tones for calls placed to the ecommerce entity. Alternatively, called party 122 may comprise another entity, such as a private individual or a type of business that contracts with an ecommerce entity to allow the ecommerce entity to predefme advertisements in multimedia ringback tones for calls placed to called party 122. In either event, when a call is placed to the directory number of called party 122, multimedia ringback system 102 identifies a multimedia ringback tone that includes an advertisement for an ecommerce entity. An ecommerce entity comprises any corporation, business, private individual, etc, that provides for the buying or selling of products and/or services over a network, such as the Internet, corporate extranets, etc.

In step 206, multimedia ringback system 102 provides the multimedia ringback tone identified in step 204 to calling party 112. Multimedia ringback system 102 may provide the multimedia ringback tone to calling party 112 in many desired ways. For instance, multimedia ringback system 102 may play the multimedia ringback tone to calling party 112 through calling device 110. In such an instance, the multimedia ringback tone may be stored in multimedia ringback system 102, multimedia ringback database 103, or another multimedia server accessible by multimedia ringback system 102. Multimedia ringback system 102 may alternatively access a multimedia server (not shown) that is storing the multimedia ringback tone, and instruct the multimedia server to play the multimedia ringback tone to calling party 112 through calling device 110. Multimedia ringback system 102 may alternatively transmit a network address (e.g., URL) to calling device 110 indicating the multimedia server that is storing the multimedia ringback tone. Calling device 110 would then automatically access the multimedia server to download the multimedia ringback tone responsive to receiving the network address.

According to features and aspects herein, as multimedia ringback system 102 is providing the multimedia ringback tone to calling party 112, network node 101 may wait for a time period (e.g., 1 minute, 2 minutes, 3 minutes, etc) before attempting to set up the call to called party 122. The time period may be predefined by called party 122, by the service provider operating communication network 100, etc. The time period delay allows calling party 112 more time to view the advertisement in the multimedia ringback tone before setting up the call to called party 122.

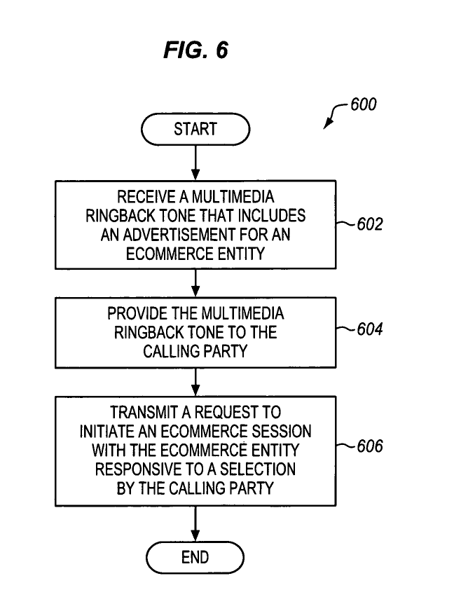

FIG. 6 is a flow chart illustrating a method of operating calling device 110 in an exemplary embodiment. As previously stated, calling device 110 comprises any communication device, such as a wireline phone, a wireless (mobile) phone, a PDA, a PC, a VoIP phone, a SIP-based phone, etc. The steps of the flow chart in FIG. 6 are not all inclusive and may include other steps not shown.

Calling device 110 receives the multimedia ringback tone from multimedia ringback system 102 in step 602. Calling device 110 then provides the multimedia ringback tone to calling party 112 in step 604 while calling party 112 waits for the call to be answered by called party 122. The multimedia ringback tone may include an audio portion and a video portion. For instance, the multimedia ringback tone may comprise an animated image along with audio, a video clip along with an audio clip, a digital picture along with an audio clip, a web page, etc. Calling device 110 may play the audio portion through a speaker, and may display the video portion through a display. No matter what the format, the multimedia ringback tone includes an advertisement for an ecommerce entity (or more than one ecommerce entity).

Calling party 112 may then view or browse the advertisement provided in the multimedia ringback tone using calling device 110. Calling device 110 may have many desired user interfaces to provide calling party 112 with browsing capabilities. If calling party 112 has further interest in the ecommerce entity, products, or services provided in the advertisement, then calling party 112 may select the ecommerce entity according to features and aspects herein. Calling party 112 may select the ecommerce entity in a variety of ways. For instance, calling party 112 may select an ecommerce entity by selecting an icon, name, picture, etc, of an ecommerce entity displayed on the screen of calling device 110, by selecting a particular product or service of the ecommerce entity displayed on the screen of calling device 110, etc. In another example, calling party 112 may select an ecommerce entity by pressing a specialized button or buttons on calling device 110 that is associated with the ecommerce entity. Responsive to the selection of the ecommerce entity by calling party 112, calling device 110 transmits a request from calling party 112 to initiate an ecommerce session with the ecommerce entity indicated in the multimedia ringback tone in step 606.

In step 208 of FIG. 2, multimedia ringback system 102 receives the request from calling party 112 to initiate an ecommerce session with the ecommerce entity indicated in the advertisement (or possibly other ecommerce entities). The request may take on any desired form. In step 210, multimedia ringback system 102 routes the call to an ecommerce server 108 of the ecommerce entity. Multimedia ringback system 102 would interrupt the call to called party 122 in routing the call to ecommerce server 108. Once the call is routed to ecommerce server 108, ecommerce server 108 may set up an ecommerce session with calling party 112 to allow calling party 112 to shop for the desired products and/or services. Multimedia ringback system 102 may transmit caller identification information or other context information to ecommerce server 108 so that ecommerce server 108 has immediate context for the ecommerce session with calling party 112.

Communication network 100 as described above advantageously promotes ecommerce using customized multimedia ringback tones. From the calling party perspective, he/she may be introduced to new products or services. From the ecommerce entity perspective, more potential customers are exposed to their products and/or services. From the perspective of the service provider operating communication network 100, revenue may be increased by selling the service of customized multimedia ringback tones to called party 122, and potentially sharing sales revenue with the ecommerce entities that are advertising using the multimedia ringback tones.

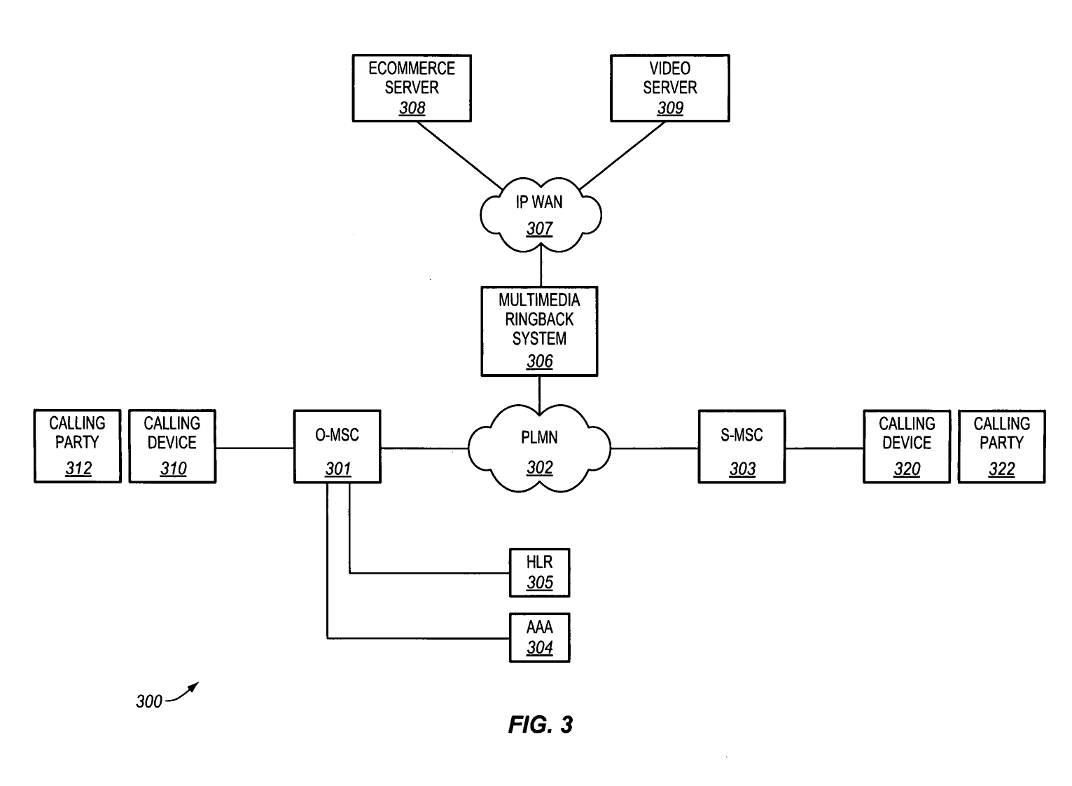

FIG. 3 illustrates another exemplary communication network 300 in an exemplary embodiment of the invention. Communication network 300 comprises a wireless network in this embodiment. Communication network 300 is adapted to provide communications between calling party 312 (through calling device 310) and called party 322 (through called device 320). Communication network 300 may include other networks, systems, or devices not shown in FIG. 3.

Communication network 300 includes an originating-MSC (O-MSC) 301 that serves calling party 312 and a serving-MSC (S-MSC) 303 that serves called party 322, each of which are connected to a Public Land Mobile Network (PLMN) 302. Communication network 300 also includes an Authentication, Authorization, and Accounting (AAA) server 304 and a Home Location Register (HLR) 305 that are accessible by O-MSC 301 and S-MSC 303. Communication network 300 also includes a multimedia ringback system 306 connected to PLMN 302. Multimedia ringback system 306 is also connected to an Internet Protocol (IP) WAN 307. An ecommerce server 308 and a video server 309 are also connected to IP WAN 307. IP WAN 307, ecommerce server 308, and video server 309 may be considered part of communication network 300, or may be considered as part of another network.

For the following description, assume that called party 322 is an ecommerce entity that has subscribed to a multimedia ringback service provided by the service provider operating communication network 300. Also assume that called party 322 has predefined one or more multimedia ringback tones that are advertisements for products and/or services of the ecommerce entity. Also assume that called party 322 has an 800 number that has been dialed by calling party 312 through calling device 310 to set up the call.

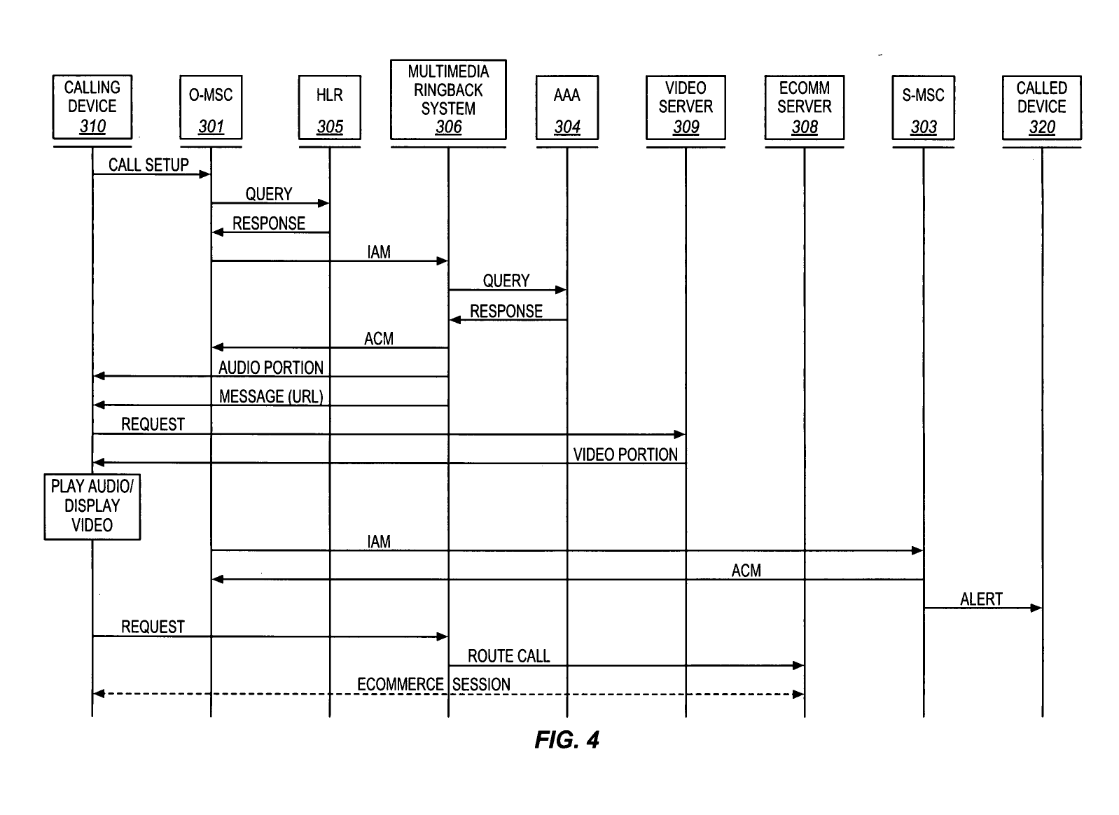

FIG. 4 is a message diagram illustrating an exemplary operation of communication network 300 in an exemplary embodiment. To start, calling party 312 places an 800 call to called party 322 by dialing the 800 number for called party 322 on calling device 310. Calling device 310 transmits call setup messages or call setup signaling for the call to O-MSC 301 that is received by O-MSC 301. Responsive to the receiving call setup messages for the call, O-MSC 301 queries HLR 305 to identify call routing and service subscription information for calling party 312 and called party 322, and receives a response from HLR 305. In this embodiment, called party 322 has subscribed to the multimedia ringback service provided by the service provider operating communication network 300. O-MSC 301 thus identifies that called party 322 has subscribed to the multimedia ringback service based on the response from HLR 305, and routes the call to multimedia ringback system 306 by transmitting an Initial Address Message (IAM) to multimedia ringback system 306.

Multimedia ringback system 306 is adapted to provide the multimedia ringback service subscribed to by called party 322. In this embodiment, multimedia ringback system 306 is to provide a multimedia ringback tone having an audio portion and a video portion for the multimedia ringback service. The audio portion may be music, songs, sound clips, audio messages, prerecorded greetings, etc. The video portion may be animated images, video clips, movies, digital pictures, etc. As will be evident below, multimedia ringback system 306 provides the audio portion for the multimedia ringback service, and uses video server 309 to provide the video portion. The audio portion and video portion may not correspond with one another. For instance, the audio portion may be a song while the video portion is an advertisement having nothing to do with the song. In other embodiment, multimedia ringback system 306 may provide both the audio portion and the video portion. In another embodiment, multimedia ringback system 306 may have video server 309 provide both the audio portion and the video portion. Multimedia ringback system 306 provides the multimedia ringback service as follows.

Responsive to the IAM, multimedia ringback system 306 queries AAA 304 for the network address of calling party 312 based on the directory number of calling party 312 provided in the IAM. AAA 304 transmits a response to multimedia ringback system 306 with the network address of calling party 312. Multimedia ringback system 306 transmits an Address Complete Message (ACM) to O-MSC 301.

Multimedia ringback system 306 identifies a multimedia ringback tone for the call. In this embodimenit, the multimedia ringback tone includes an audio portion and a video portion. Multimedia ringback system 306 stores the audio portion and plays the audio portion to calling party 312 through O-MSC 301 and calling device 310.

The video portion of the multimedia ringback tone is stored remotely in video server 309. Thus, multimedia ringback system 306 transmits a message to calling device 310 of calling party 312 with an HTTP URL for the video portion stored in video server 309. Responsive to receiving the message with the URL, calling device 310 of calling party 312 automatically transmits a request for the video portion to video server 309. Video server 309 transmits the video portion to calling device 310. Video server 309 may transmit the video portion over IP WAN 307 to calling device 310 using HTTP, or may transmit the video portion to calling device 310 through multimedia ringback system 306 and O-MSC 301. If the video portion is transmitted over IP WAN 307, then calling device 310 receives the audio portion of multimedia ringback tone over the circuit-based session with multimedia ringback system 306 and receives the video portion of multimedia ringback tone over the packet-based session with video server 309.

Calling device 310 plays the audio portion provided by multimedia ringback system 306 to calling party 312 and displays the video portion provided by video server 309 to calling party 312 while calling party 312 waits for called party 322 to answer the call. The video portion and/or audio portion comprise one or more advertisements for one or more ecommerce entities. Calling party 312 may browse the multimedia advertisement for products, services, etc.

Concurrent with the messaging described above, O-MSC 301 also attempts to set up the call to called party 312. O-MSC 301 transmits an IAM to S-MSC 303. Responsive to receiving the IAM, S-MSC 303 transmits an Address Complete Message (ACM) to O-MSC 301. S-MSC 303 also provides alerting (e.g., ringing) to called party 322 through called device 320. O-MSC 301 may transmit the IAM to S-MSC 303 in parallel with the LIM transmitted to multimedia ringback system 306. In some embodiments, called party 322 may define a time period (e.g., 2 minutes, 3 minutes, etc) of playing the advertisements in the multimedia ringback tone before which O-MSC 301 attempts to set up the call to called party 322. This allows calling party 312 more time to view the advertisements before called party 322 answers the call.

If calling party 312 has further interest in one or more of the ecommerce entities provided in the advertisements, then calling party 312 may select an ecommerce entity according to features and aspects herein. Calling party 312 may select an ecommerce entity in a variety of ways. For instance, calling party 312 may select an ecommerce entity by selecting an icon, name, picture, etc, of an ecommerce entity displayed on the screen of calling device 310, by selecting a particular product or service of an ecommerce entity displayed on the screen of calling device 310, etc. In another example, calling party 312 may select an ecommerce entity by pressing a specialized button or buttons on calling device 310 that is associated with an ecommerce entity. Responsive to the selection of the ecommerce entity by calling party 312, calling device 310 generates a request to initiate an ecommerce session and transmits the request to multimedia ringback system 306.

Multimedia ringback system 306 routes the call to an ecommerce server 308 of the ecommerce entity. Multimedia ringback system 306 would interrupt the call to called party 322 in routing the call to ecommerce server 308. Once the call is routed to ecommerce server 308, ecommerce server 308 may set up an ecommerce session with calling device 310 to allow calling party 312 to shop for the desired products or services.

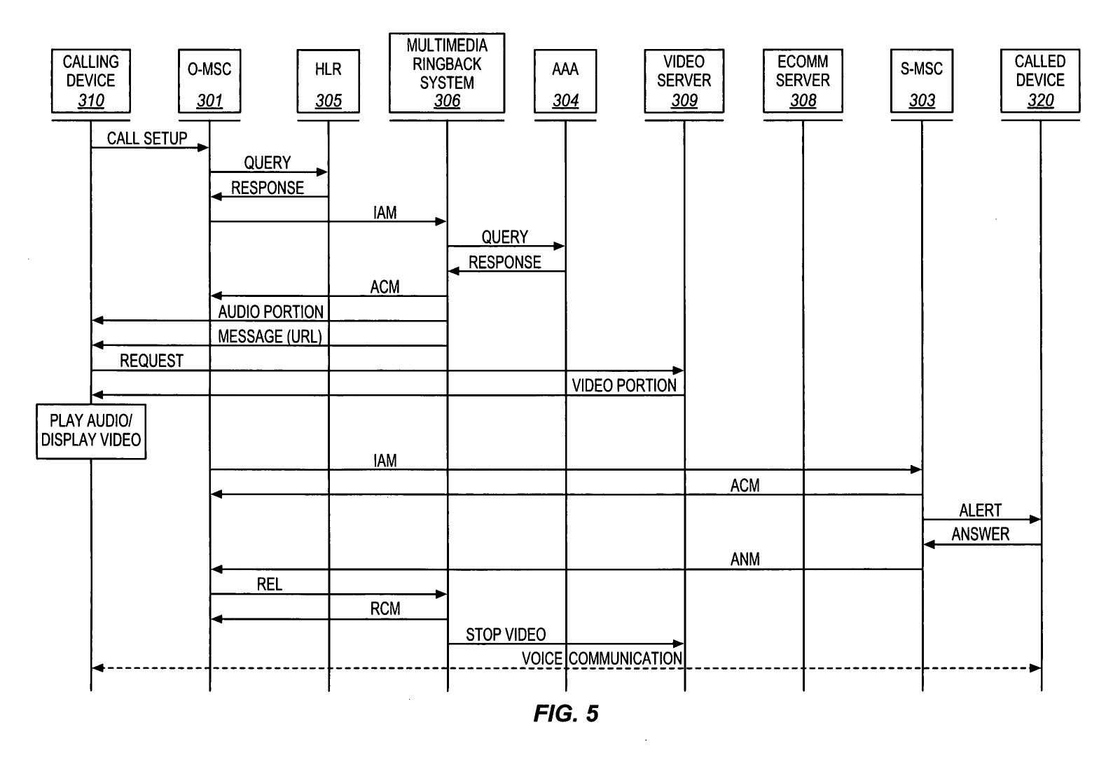

If called party 322 answers the phone before calling party 312 selects an ecommerce entity, then the call is established between called party 322 and calling party 312. FIG. 5 is a message diagram illustrating another exemplary operation of communication network 300 in an exemplary embodiment. FIG. 5 shows the example of when called party 322 answers the call. The messaging in FIG. 5 is the same as is FIG. 4 except that calling party 312 does not request to initiate an ecommerce session with an ecommerce entity.

After S-MSC 303 provides the alert to called device 320, assume that called party 322 answers the call. Responsive to answering the call, S-MSC 303 transmits an Answer Message (ANM) to O-MSC 301. O-MSC 301 transmits a release message (REL) to multimedia ringback system 306. O-MSC 301 also bridges the call legs for calling party 312 and called party 322. Voice communications are established between calling party 312 and called party 322.

Responsive to the REL message, multimedia ringback system 306 stops transmitting the audio portion to calling device 310 and releases the trunks and associated resources for the audio ringback. Multimedia ringback system 306 then transmits a Release Complete Message (RCM) to O-MSC 301. Multimedia ringback system 306 also transmits a stop message to video server 309 to instruct video server 309 to stop transmitting the video portion to calling device 310.

Although specific embodiments were described herein, the scope of the invention is not limited to those specific embodiments. The scope of the invention is defined by the following claims and any equivalents thereof.

I claim:

1. A communication network for providing ecommerce services using multimedia ringback tones, the communication network comprising:
a multimedia ringback system; and
a network node adapted to receive a call from a calling party to a called party, and route the call to the multimedia ringback system;
the multimedia ringback system adapted to identify a multimedia ringback tone for the call that includes an advertisement for an ecommerce entity, and provide the multimedia ringback tone to the calling party while the calling party waits for the call to be answered by the called party;
the multimedia ringback system is further adapted to receive a request to initiate an ecommerce session with the ecommerce entity indicated in the multimedia ringback tone, and route the call to an ecommerce server of the ecommerce entity responsive to the request.

2. The communication network of claim 1 wherein the multimedia ringback tone includes at least an audio portion and a video portion.

3. The communication network of claim 2 wherein:
the audio portion comprises at least one of music, a song, a sound clip, an audio message, or a prerecorded greeting; and
the video portion comprises at least one of an animated image, a video clip, a movie, or a digital picture.

4. The communication network of claim 1 wherein the multimedia ringback tone is stored locally on the multimedia ringback system and is provided to the calling party by the multimedia ringback system.

5. The communication network of claim 1 wherein the multimedia ringback tone is stored in a server remote from the multimedia ringback system and is provided to the calling party by the remote server responsive to a request by the multimedia ringback system.

6. The communication network of claim 1 wherein the communication network comprises one of a wireless network, a wireline network, or an IMS network.

7. The communication network of claim 1 wherein the ecommerce server is local to the communication network.

8. The communication network of claim 1 wherein the ecommerce server is remote from the communication network.

9. The communication network of claim 1 wherein the call comprises an 800 call to the ecommerce entity.

10. The communication network of claim 1 wherein the network node is adapted to wait for a time period before attempting to set up the call to the called party.

11. The communication network of claim 1 wherein the multimedia ringback system is adapted to select the multimedia ringback tone based on a directory number of the calling party.

12. A method of operating a communication network for providing ecommerce services using multimedia ringback tones, the method comprising:
receiving a call from a calling party to a called party;
identifying a multimedia ringback tone for the call that includes an advertisement for an ecommerce entity;
providing the multimedia ringback tone to the calling party while the calling party waits for the call to be answered by the called party;
receiving a request to initiate an ecommerce session with the ecommerce entity indicated in the multimedia ringback tone; and
routing the call to an ecommerce server of the ecommerce entity responsive to the request.

13. The method of claim 12 wherein the multimedia ringback tone includes at least an audio portion and a video portion.

14. The method of claim 13 wherein:
the audio portion comprises at least one of music, a song, a sound clip, an audio message, or a prerecorded greeting; and
the video portion comprises at least one of an animated image, a video clip, a movie, or a digital picture.

15. The method of claim 12 wherein the communication network comprises one of a wireless network, a wireline network, or an IMS network.

16. The method of claim 12 further comprising:
waiting for a time period before attempting to set up the call to the called party.

17. A method of operating a communication device for providing ecommerce services using multimedia ringback tones responsive to transmitting a call from a calling party to a called party, the method comprising:
receiving a multimedia ringback tone for the call that includes an advertisement for an ecommerce entity;
providing the multimedia ringback tone to the calling party while the calling party waits for the call to be answered by the called party; and
transmitting a request to initiate an ecommerce session with the ecommerce entity indicated in the multimedia ringback tone responsible to a selection of the ecommerce entity by the calling party.

18. The method of claim 17 wherein the multimedia ringback tone includes at least an audio portion and a video portion.

19. The method of claim 18 wherein:
the audio portion comprises at least one of music, a song, a sound clip, an audio message, or a prerecorded greeting; and
the video portion comprises at least one of an animated image, a video clip, a movie, or a digital picture.

20. The method of claim 18 wherein providing the multimedia ringback tone comprises:
playing the audio portion of the multimedia ringback tone through a speaker; and
displaying the video portion of the multimedia ringback tone through a display.
